(19) United States
(12) Patent Application Publication
(10) Pub. No.: US 2003/0134018 A1
(43) Pub. Date: Jul. 17, 2003

(54) Process for oil extraction

(75) Inventors: Matthew S. Turner, Union City, TN (US); Leroy Venne, Fridley, MN (US)

Correspondence Address: FOLEY & LARDNER, 777 EAST WISCONSIN AVENUE, SUITE 3800, MILWAUKEE, WI, 53202-5308, US

(73) Assignee: Cargill, Inc.

(21) Appl. No.: 10/036,331

(22) Filed: Dec. 31, 2001

(51) Int. Cl. A23L 1/28; C10G 1/04

(52) U.S. Cl. 426/430; 208/309; 208/45; 208/435

(57) ABSTRACT

A process for the selective extraction of desired compounds from solid materials, and more particularly, a process for oil extraction from oil-bearing materials with a hydrocarbon solvent composition is provided. The method includes contacting the oil-containing solids with a particular type of hydrocarbon solvent to form an extraction mixture.

### BACKGROUND

Oils may be extracted from a variety of plant materials including oil seeds, cereal brans, fruits, beans, and nuts. Extracted oil is the source of raw material for many important commercial products. For example, oils from plant materials, such as those derived from corn, are extensively used in cooking, other oils are used in processed foods, are used in cosmetics, serve as carriers for pharmaceuticals, insecticides and fungicides, and are used as lubricants. Consequently, processes for extracting oil from such materials has been developed and improved over the years.

Solvent extraction is one of the most widely used processes for removing oil from plant materials. In solvent extraction, the plant material is treated with a suitable solvent to extract oil from the plant material under various times, pressures and temperatures, depending on the solvent employed and the nature of the oil to be extracted from the plant materials. Generally, the longer time that the solvent contacts the plant material, the greater volume of oil will be recovered from the plant material. The pressure conditions of the extraction are important to help maintain the state of the solvent during extraction, and to facilitate separation of the solvent from the extracted oil. Pressure adjustments can also decrease energy demands and increase oil purity by decreasing the wet dew point temperature of the solvent through reduction in pressure, which allows vaporization or “flashing” of the solvent with less energy input. Operating pressures for solvent removal/recovery of about 300 to 400 millimeters of mercury (mm Hg) are desirable to achieve low levels of residual solvent in the extracted oil and to reduce operating temperatures. All references to mm Hg herein are references to pressures as measured in such units.

Additionally, the operating temperature can impact oil extraction. At elevated temperatures, oil is more easily extracted from plant material. It is also possible to extract substantially all of the oil from the plant materials over a relatively wide range of temperatures, when employing a sufficient quantity of solvent. However, temperatures which are too high may damage the oil through degradation and/or discoloration.

Suitable solvents for use in oil extraction include commercially available solvents that permit solubility of the oil under normal reaction conditions. Desirably, solvents used in oil extraction should: (1) allow solubilization of oil from plant material, (2) have a wet bubble point high enough to remain liquid at operating temperatures and pressures to prevent excess vapor load and yet low enough to be readily condensed at close to ambient temperatures for solvent recovery, and (3) have a wet dew point that will facilitate stripping the residual solvent from the oil at temperatures that will not adversely effect the quality of oil or cost of oil extraction.

The low-boiling alkanes represent a desirable class of solvents because of their relative inertness, low cost and ease of separation from the oil. However, alkanes such as propane, butane and pentane have wet bubble points that make it difficult to remain liquid at operating temperatures and are also difficult to condense. Use of these alkanes requires a system that uses a large amount of energy to capture the resultant solvent vapor load produced during the oil extraction and purification process. Furthermore, there is an increased chance that these lighter hydrocarbons will escape the system, causing environmental problems. Conversely, higher-boiling hydrocarbons remain liquid at convenient operating temperatures, but have wet dew points at readily achievable vacuum conditions temperatures that can result in oil degradation and discoloration during the stripping process. Of the commercially available hydrocarbon solvents, n-hexane has been regarded as the solvent with the most desirable overall physical characteristics, having a wet bubble point high enough to remain liquid at operating temperatures yet low enough to easily condense and a wet dew point low enough to easily strip the residual solvent from the oil without any adverse effects.

n-Hexane has recently, however, begun to lose favor in the oil extraction industry. N-hexane has been listed as substance to monitor under the Superfund Amendments and Reauthorization Act of 1986 (SARA). Accordingly, n-hexane use and disposal is regulated under SARA, and the government reporting standards associated with SARA can place costly burdens on companies using n-hexane. Although n-hexane remains suitable for use in many oil extraction processes, companies are searching for other solvents that may be substituted for n-hexane in an attempt to reduce solvent oil extraction costs.

To this end, companies have attempted to substitute n-hexane with other hydrocarbon blends, which are preferably not listed under SARA. However, other hydrocarbon blends have proved difficult to use in oil extraction systems designed to be run with n-hexane. The primary problem with other hydrocarbon blends is the difference in wet bubble point temperatures between the other hydrocarbon blends and n-hexane. The wet bubble point of the other hydrocarbon blends must remain high enough to maintain the hydrocarbon blends in liquid state at normal operating pressures and temperatures. However, a hydrocarbon blend with a wet bubble point sufficiently lower than n-hexane is more difficult to condense, and can cause vapor scrubbers to overload, resulting in hydrocarbon loss into the atmosphere. A lower wet bubble point can also increase the vapor load within the system, requiring more energy and/or more efficient condensing systems to maintain a given vacuum pressure. To accommodate these system deficiencies due to decreased wet bubble point, expensive capital improvements may be required to adjust the system, including the installation of chillers and condensers to capture the vaporized hydrocarbons and alterations in duct sizes to accommodate larger vapor loads.

Now, as before, there remains a need for a solvent composition other than n-hexane for use in oil extraction processes and to overcome the problems and disadvantages associated with the state of the art as described above. Therefore, an objective of the present invention is to provide a process for oil extraction that utilizes a hydrocarbon solvent other than n-hexane. The hydrocarbon solvent should be capable of remaining in liquid state at operating temperatures during the extraction process, yet be easily vaporized to substantially remove residual hydrocarbon solvent from the extracted oil.

Alternate extraction processes will desirably permit oil extraction at temperatures low enough to prevent oil degradation and discoloration. Such processes will suitably utilize a hydrocarbon solvent capable of being condensed at ambient or close to ambient temperatures to capture vaporized hydrocarbon solvent for recycling purposes and also to avoid blow-off of the vaporized hydrocarbon solvent into the atmosphere. The process should also use a hydrocarbon solvent that may be capable of being introduced into an oil extraction system designed for n-hexane without having to make significant capital improvements to the system. Additionally, the hydrocarbon solvent used in the process for oil extraction of the present invention should be readily attainable from commercial sources.

### SUMMARY

The present invention relates to selective extraction of desired compounds, and more particularly, to a process for oil extraction from oil-bearing materials, e.g., carbonaceous materials, with a hydrocarbon solvent composition.

In light of the problems and disadvantages associated with traditional processes for oil extraction, a process for separating oil from oil-containing solids using an aliphatic hydrocarbon solvent is provided herein. As used herein, “aliphatic hydrocarbon solvent” refers to a hydrocarbon solvent composed of at least about 99 wt. % aliphatic hydrocarbon compounds. As used herein, the term “aliphatic” includes both acyclic and cyclic hydrocarbons.

The aliphatic hydrocarbon solvent typically has a wet bubble point at 760 mm Hg of about 134.5° F. to about 140° F. As used herein, “wet bubble point” refers to the calculated liquid saturation temperature at a specified pressure of a given hydrocarbon solvent that is saturated with water at 100° F. where the saturation point is determined by a flash calculation setting the vapor fraction is equal to 0 as calculated using the UNIQUAC activity coefficient model with Aspen Plus, version 10.2 software, developed by Aspen Technology of Cambridge, Mass.

The aliphatic hydrocarbon solvent employed in the present process preferably includes no more than about 1 wt. % n-hexane and no more than about 10 ppm benzene. The aliphatic hydrocarbon solvent employed in the present process generally includes at least about 85 wt. % methylpentane. As used herein, “methylpentane” refers to 2-methylpentane, 3-methylpentane, or a combination thereof. Suitable aliphatic hydrocarbon solvents for use in the present method desirably include a ratio of methylpentane isomers such that the solvent includes at least about 30 wt. % 3-methylpentane, and more desirably, at least about 35 wt. % 3-methylpentane.

An aliphatic hydrocarbon solvent particularly suited for the process described herein includes at least about 99 wt. % branched saturated aliphatic hydrocarbons having 6 carbon atoms. Aliphatic hydrocarbon solvents which are even more well suited for the present oil extractions include at least about 99.9 wt. % branched saturated aliphatic hydrocarbons having 6 carbon atoms.

The present process for separating oil from oil-containing solids typically includes contacting the oil-containing solids with an isohexane solvent to form an extraction mixture. As used herein, “isohexane solvent” refers to a hydrocarbon solvent that includes at least 99 wt. % saturated aliphatic hydrocarbons having 6 carbon atoms and less than 1 wt. % n-hexane.

To provide an isohexane solvent that has advantageous properties over commercially available isohexane, the isohexane solvent used in the process for oil extraction commonly has a wet bubble point at 375 mm Hg of at least 97° F., and generally includes at least about 85 wt. % methylpentane. Preferably, the isohexane solvent has a wet bubble point of at least 98° F. at 375 mm Hg and, more desirably, at least 99° F. at 375 mm Hg.

An isohexane solvent particularly suited for the present process may include at least about 20 wt. % 3-methylpentane, and more preferably at least about 35 wt. % 3-methylpentane. The isohexane solvent typically also includes some dimethylbutane. As used herein, “dimethylbutane” refers to 2,2-dimethylbutane, 2,3-dimethylbutane, or a combination thereof. In an isohexane solvent particularly suited for the process for oil extraction, the total dimethylbutane content is no more than about 10 wt. %, with a total dimethylbutane content of no more than about 5 wt. % being particularly desirable. The isohexane solvent should preferably also contain very low levels of 2,2-dimethylbutane, since this is the lowest boiling isohexane isomer. Suitably isohexane solvents have no more than about 7 wt. % 2,2-dimethylbutane, more preferably no more than about 5 wt. % 2,2-dimethylbutane, and more preferably no more than about 3 wt. % 2,2-dimethylbutane. Isohexane solvent employed in the present process generally include no more than about 1 0 parts per million benzene.

The process for separating the oil from the oil-containing solids may also include separating the extraction mixture into a solids-containing fraction and an oil-containing solvent fraction. The solids-containing fraction may then be further processed to remove the solids and recover isohexane solvent. This may be accomplished, for example, by vaporizing the isohexane solvent. The oil-containing solvent fraction may also be further separated into a low solvent-oil fraction and solvent fraction. Again, this may be accomplished by vaporizing the isohexane solvent.

Further separation of the oil-containing fraction may be done in a two stage process. In the first stage, the bulk of the solvent is separated from the oil-containing fraction. In the second stage, the resulting solvent-depleted oil-containing fraction is commonly heated under vacuum to vaporize substantially all of the residual solvent. Sufficient solvent is preferably removed to provide a low solvent-oil fraction, which has no more than about 250 parts per million isohexane solvent, and more preferably has no more than about 1 00 parts per million isohexane solvent.

The present process for separating oil from oil-containing solids may also be carried out by contacting the oil-containing solids with an isohexane solvent that has a wet dew point at 325 mm Hg of at least 97° F. As used herein, “wet dew point” refers to the calculated vapor saturation temperature at a specified pressure of a given hydrocarbon solvent that is saturated with water at 100° F. where the saturation point is determined by a flash calculation setting the vapor fraction is equal to 1 as calculated using the UNIQUAC activity coefficient model with Aspen Plus, version 1 0.2 software, developed by Aspen Technology of Cambridge, Mass. Such isohexane solvents commonly include at least about 85 wt. % methylpentane, with solvents including at least 90 wt. % methylpentane being particularly suitable.

It is generally desirable to employ an isohexane solvent which contains no more than about 0.1 wt. % hydrocarbons having less than 6 carbon atoms. The isohexane solvent also desirably has a very low level of 2,2-dimethylbutane, e.g., no more than about 3 wt. % 2,2-dimethylbutane. Preferably, the isohexane solvent suitably has a wet dew point at 350 mm Hg of at least 101° F. and, alternatively, has a wet dew point temperature at 325 mm Hg of no more than 105° F.

The present process can employ an isohexane solvent including at least about 84 wt. % methylpentane, no more than about 7 wt. % 2,2-dimethylbutane, no more than about 0.1 wt. % hydrocarbons having less than 6 carbon atoms, and no more than about 10 ppm benzene. This isohexane solvent suitably has a wet bubble point at 760 mm Hg of at least 1 34° F. This isohexane solvent would be suitable for use in separating oil from oil-containing solids. A more desirable isohexane solvent for use in the present method includes at least about 90 wt. % methylpentane, at least about 1 wt. % 2,3-dimethylbutane, no more than about 1 wt. % 2,2-dimethylbutane, and no more than about 1 wt. % n-hexane. This latter solvent preferably includes no more than about 10 ppm aromatic compounds, such as benzene.

A method of producing a plant based oil product by separating a solids-containing fraction and a solvent-oil fraction, and transferring energy to the solvent-oil fraction at an initial distillation stage to produce a vapor phase which includes aliphatic hydrocarbon solvent is also provided herein. The temperature of the vapor phase will vary depending on the pressure of the system. For example, systems under vacuum (e.g., at a pressure of about 350 mm Hg (circa 16 in. vacuum)) will require less energy input and will have a lower temperature vapor phase than systems at atmospheric pressure (760 mm Hg). Suitably, the present process employs a solvent such that the vapor phase has a temperature of at least X°F, where X=97+((P−350)/7.14) and no more than Y°F, where Y=105+((P−350)/7.14), and P is the system pressure in mm Hg. Typically, a system with a pressure of about 300 to 400 mm Hg (i.e., a system under a vacuum of about 18 to 14 in) is used to remove solvent from the oil-containing solvent fraction. Desirably, a solvent is selected such that solvent is removed from the oil-containing solvent fraction under conditions where the vapor phase has a temperature of at least X°F, where X=98+((P−350)/7.14). Solvent and systems where the solvent vapor can be removed at a system pressure of about 325 to 375 mm Hg and a vapor temperature of at least X°F, where X=99+((P−350)/7.14), are particularly suitable for use in the present method.

The oil-containing solids described herein may be derived from plant material. Examples of plant material may include material derived from corn, soybean, copra, safflower, sunflower, cotton, hemp, rope, sesame, palm, flax, peanut, and combinations thereof. Presently, corn germ and soybean account for much of the oil-containing solid material, although this may change in the future due to another source of oil becoming more widely available and/or more cost effective.

As described herein, the process for oil extraction of the present invention utilizes a hydrocarbon solvent other than n-hexane. The hydrocarbon solvent is capable of remaining in liquid state at operating temperatures during the extraction process, yet can be easily vaporized to substantially remove residual hydrocarbon solvent from the extracted oil.

The present process for oil extraction can also permit oil extraction at temperatures low enough to prevent oil degradation and discoloration.

Additionally, the present process can utilize a hydrocarbon solvent capable of being condensed at ambient temperatures to capture vaporized hydrocarbon solvent for recycling purposes and also to minimize blow-off of the vaporized hydrocarbon solvent into the atmosphere, thereby minimizing environmental concerns associated with the process. The hydrocarbon solvent used in the present process for oil extraction is preferably capable of being introduced into an oil extraction system designed for n-hexane without having to make significant capital improvements to the system. Additionally, the hydrocarbon solvent used in the process for oil extraction of the present invention generally readily attainable from a commercial source.

It is to be understood that both the foregoing summary of the invention and the following detailed description are of exemplary embodiments, and not restrictive of the invention or other alternate embodiments of the invention.

### BRIEF DESCRIPTION OF THE DRAWINGS

FIG. 1 is a schematic diagram of one example of a process for oil extraction.

FIG. 2 is a graph illustrating the wet bubble points of four different isohexane compositions at various pressures.

FIG. 3 is a graph illustrating the wet dew points of four different isohexane compositions at various pressures.

### DETAILED DESCRIPTION

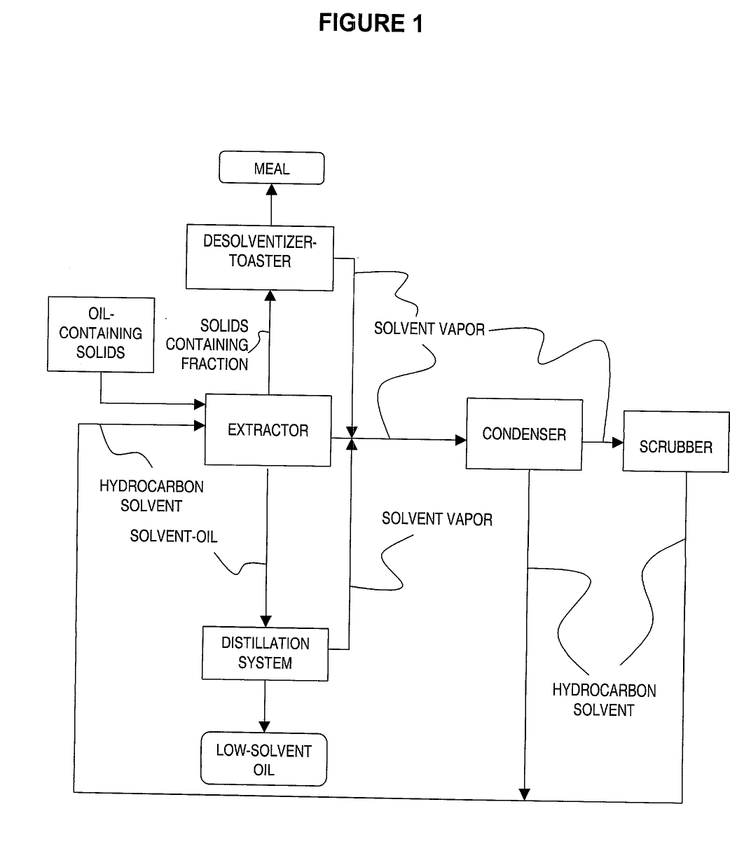

Referring now to the drawings, FIG. 1 shows an example of a process for oil extraction. First, oil-containing solids and hydrocarbon solvent are combined within an extractor. The extractor is commonly maintained at a temperature of about 110° F. to 136° F. at or slightly below atmospheric pressure in an attempt to prevent vaporization of the hydrocarbon solvent yet promote oil extraction. Desirably, the extractor equilibrates at a temperature of within about 3° F. of the wet bubble point of the hydrocarbon solvent. However, the temperature and pressures may vary depending on the degree of separation desired, and the physical characteristics of the hydrocarbon solvent and extracted oil.

Generally, the extractor continuously receives oil-containing solids through a vapor lock or seal, which prevents the hydrocarbon solvent vapors from escaping out of the extractor. The oil-containing solids are contacted and mixed with hydrocarbon solvent to separate the oil from the oil-containing solids and form an extraction mixture. The oil-containing solids may include any carbonaceous material including material derived from corn, soybean, copra, safflower, sunflower, cotton, hemp, rape, sesame, palm, linseed, peanut, cereals such as rice bran, wheat bran and cornmeal, as well as small particle products such as food coatings and meats. Additionally, the oil-containing solids may contain substances other than oil which may be removed in the process of the present invention including, without limitation, phospholipids, fats, fatty acids, alcohols, waxes, gums, sterols, oil soluble proteins, flavonol, mineral oils, essential oils, and PCBs.

The resultant extraction mixture is a slurry of an oil-containing solvent fraction and a solids-containing fraction. The oil-containing solvent fraction includes the hydrocarbon solvent with the extracted oil solubilized therein. The solids-containing fraction contains the oil-depleted, oil-containing solids saturated or partially-saturated with hydrocarbon solvent. The oil-containing solvent fraction and the solids-containing fraction are then separated and processed to remove the hydrocarbon solvent from each fraction.

For example, the oil-containing solvent fraction is drained into pumps and transferred to a distillation system. Entering the distillation system from the extractor, the oil-containing solvent fraction typically contains about 1 5% to 30% oil. Within the distillation system the oil-containing solvent fraction is further separated into a solvent fraction and a low solvent-oil fraction by methods commonly known to those skilled in the art. Common methods include using a combination of evaporators and strippers to heat the oil-containing solvent fraction under negative pressure (i.e. system pressures which are below ambient pressure) to vaporize the hydrocarbon solvent into the solvent fraction. The oil-containing solvent fraction enters an initial distillation stage from the extractor, where the oil-containing solvent fraction is heated to remove at least a substantial fraction of the solvent present. As used herein, “initial distillation stage” refers to a distillation stage in which energy is applied to an oil-solvent mixture having substantially the same composition as the liquid phase output from the extractor stage of the process. Commonly, the output from the initial distillation stage is an oil-containing fraction with about 60% to 80% oil before being transferred to a second distillation stage. At the second distillation stage, the oil-containing solvent fraction can be further separated to provide an oil- containing solvent fraction with approximately 90% to 99% oil. This process may continue with other distillation stages until the low solvent-oil fraction is obtained. For many end uses, the low solvent-oil fraction should desirably have no more than about 250 parts per million hydrocarbon solvent, and more preferably no more than about 100 parts per million hydrocarbon solvent, although this may vary depending on specifications desired. Commonly, the hydrocarbon solvent is vaporized at about 300 to 375 mm Hg to facilitate efficient solvent removal, and to keep residual hydrocarbon solvent amounts low within the low solvent-oil fraction. Although a particular distillation system is discussed herein, it would be apparent to those skilled in the art to use other types of distillation systems to achieve the same objective.

The hydrocarbon solvent can also be removed from the still solvent- wet solids-containing fraction by transferring the solids-containing fraction to a desolventizer-toaster. There the solids-containing fraction may be heated under negative pressure (“vacuum”) to further separate the solids-containing fraction into a recovered solvent fraction and a meal fraction. The meal contains proteins which, if undamaged, may be used for human food or animal feed, e.g. soy flour or soybean meal.

In each separation, the solvent fraction is typically separated from the oil-containing solvent fraction and the solids-containing fraction by vaporization. The vaporized hydrocarbon solvent from each separation is commonly maintained within a closed system and can be condensed for return to the extractor. Any vaporized hydrocarbons which are not condensed may be trapped within a scrubber, such as a mineral oil collector. The condensed and/or collected hydrocarbons may then collected and recycled for further use.

The process for oil extraction as shown and described contains a number of system stress points including the extractor, the distillation system, the desolventizer-toaster, the condenser and the scrubber. In large part, the system requirements and operating conditions for each of these stress points depends on the physical characteristics of the hydrocarbon solvent, namely the wet bubble point and wet dew point of the hydrocarbon solvent. The wet bubble point is an important characteristic for the separation of oil from oil-containing solids. The wet bubble point provides an indicator of the propensity of the hydrocarbon solvent to remain in liquid phase during the separation process. The temperature and pressure conditions in the extractor desirably are selected to maintain the temperature of oil-containing solids and hydrocarbon solvent below the wet bubble point in order to minimize the vapor load in the system. The wet bubble point is also important for condensing the vaporized hydrocarbon solvent because the condenser must chill the hydrocarbon vapor below the wet bubble point to completely condense the hydrocarbon solvent into a liquid phase, typically at negative pressure.

Another stress point of the process is the scrubber, which works in conjunction with the condenser. Like the condenser, the efficiency of the scrubber is also dependent upon the wet bubble point of the hydrocarbon solvent. The scrubber works best when limited amounts of hydrocarbon vapor reach the scrubber. Some vapor can, however, escape the scrubber when the scrubber is exposed to a higher vapor load. A substantial portion of the vapor load is produced from the extractor, the solvent removal distillation system and the desolventizer-toaster. For example, a large amount of hydrocarbon vapor is produced when the oil-containing solids enter the extractor at temperatures up to and exceeding about 1 30° F. This can cause vaporization of the hydrocarbon solvent when the hydrocarbon solvent has a wet bubble point that is near or below the incoming temperature of oil-containing solids.

Wet dew point temperature is also an important physical characteristic of the hydrocarbon solvent. In particular, wet dew point is important when separating the residual solvent from the oil-containing solvent fraction and the solids-containing fraction of the extraction mixture. This is because the temperatures in the distillation system and the desolventizer-toaster should be above the wet dew point of the hydrocarbon solvent to substantially remove all of the hydrocarbon solvent from the oil-containing solvent fraction and the solids-containing fraction. To reduce heating costs and increase vaporization, the system is commonly placed under negative pressures, which effects the vapor points of the hydrocarbon solvent causing lower wet bubble point and wet dew point temperature.

The effect of wet bubble point temperature on system requirements is emphasized by the data presented in Table 2 below, which displays calculated required cooling surface areas needed to condense five different hydrocarbon solvents at 375 mm Hg, including four different isohexanes and a commercial n-hexane. The compositions of the five hexane solvents are shown in Table 1 below. The commercial n-hexane blend is representative of n-hexane solvents which are widely used to extract oil from plant-derived materials. “Isohexane 1” is an isohexane blend which has been used in some commercial oil extraction processes. Its bubble point and proportion of volatile components present are such that problems may be experienced due to high vapor loads, particularly during solvent removal/recovery phases of the process.

TABLE 1

| | Isohexane | Isohexane | Isohexane | Isohexane | Com'l |
|---|---|---|---|---|---|
| Chemicals | 1 | 2 | 3 | 4 | n-hexane |
| n-pentane | 0.16 | — | — | — | 0.03 |
| 2,2-dimethyl | 7.37 | 5 | 2 | 1 | 0.01 |
| butane | | | | | |
| 2,3-dimethyl | 13.97 | 10 | 3 | 2 | 0.41 |
| butane | | | | | |
| 2-methyl | 50.68 | 50 | 50 | 40 | 5.14 |
| pentane | | | | | |
| 3-methyl | 27.77 | 35 | 45 | 57 | 12.45 |
| pentane | | | | | |
| n-hexane | 0.05 | — | — | — | 68.45 |
| Methyl- | — | — | — | — | 13.39 |
| Cyclopen- | | | | | |
| tane | | | | | |
| Cyclohexane | — | — | — | — | 0.1 |

The required cooling surface areas listed in Table 2 were calculated for a typical plant running 3000 tons per day of oil-containing solids (e.g., corn germ) using 170,000 pounds per hour of hydrocarbon solvent and using 7000 gallons per minute of 95° F. cooling water to condense the vaporized hydrocarbon solvent. The calculations were carried out using the Aspen Plus, v.10.2 software and assuming a heat transfer coefficient of 150 Btulhr/ft²/° F. Ambient cooling water temperature can reach between approximately 85° F. and 95° F. during summer months in many regions, and thus 95° F. is often utilized as the temperature at which to evaluate the usefulness of a hydrocarbon solvent for oil extraction processes. The ambient temperature may decrease during winter months, however, a system is generally designed to be capable of running through the full range of temperatures expected to be encountered during year-round production.

TABLE 2

| | | | | | Com'l |
|---|---|---|---|---|---|
| Physical | Isohexane | Isohexane | Isohexane | Isohexane | n- |
| Characteristics | 1 | 2 | 3 | 4 | hexane |
| Wet bubble | 96.08 | 97.11 | 98.43 | 99.2 | 108.63 |
| point (° F.) | | | | | |
| Wet dew point | 103.06 | 104.01 | 105.25 | 106.04 | 117.22 |
| (° F.) | | | | | |
| Cooling Area | 51315 | 41154 | 30061 | 25876 | 9685 |
| at 95° F. (Sq. | | | | | |
| Ft.) | | | | | |

As is shown in Table 2, when the bubble point of the solvent nears the temperature of the cooling water, very small changes in wet bubble point temperatures can dramatically affect the amount of cooling surface area required to condense the vaporized hydrocarbon solvent. Within a degree difference between the wet bubble point and ambient cooling water temperature of 95° F., the required cooling surface area is about 51,300 square feet (Isohexane 1). However, when the difference is at least 2° F. between wet bubble point temperature and ambient temperature, the required cooling surface area decreases by about 20% (Isohexane 2). With about 3° F. difference, the required cooling surface area decreases by about 37% (Isohexane 3), and with 4° F. difference, the required cooling surface area decreases about 50% (Isohexane 4). A temperature difference between the cooling water temperature and the wet bubble point of the hydrocarbon solvent of at least 2° F. is generally desired to provide a sufficient impact on operating conditions and equipment. More preferably, the difference between cooling water and the calculated wet bubble point should at least 3° F.

Table 2 also illustrates that the required capital improvement costs for condensers required to remove vaporized hydrocarbons from the oil extraction system would increase substantially when using a hydrocarbon solvent with a wet bubble point at 375 mm Hg of 960 F, as opposed to a hydrocarbon solvent with a wet bubble point at 375 mm Hg of at least 97° F. or 98° F. or higher. The costs would continue to decrease as the wet bubble point of the hydrocarbon solvent increases over 99° F.

As such, the hydrocarbon solvent used to separate the oil from the oil-containing solids suitably has a wet bubble point temperature of at least 97° F. at common desired operating pressures. Generally, operating pressure ranging from 300 to 375 mm Hg are desired for the distillation and condensation segments of the process for oil extraction. However, the pressure preferably remains at or below 350 mm Hg. If vacuum pressure is compromised, more energy will be required to heat the oil-containing solvent fraction and/or the solids-containing fraction to a higher temperature to remove residual hydrocarbon solvent, and more cooling surface area will be required to condense the increased hydrocarbon vapor.

To reach these parameters, isohexane has been determined to most closely resemble n-hexane. Isohexane is not listed under SARA. Commercially available isohexanes generally include a mixture of methylpentanes, dimethylbutanes and numerous types of other ancillary hydrocarbons including benzene, n-hexane, cyclohexane, pentanes, butanes, and propanes. Table 3 below presents the boiling point temperatures for each of the hydrocarbon compounds typically found in commercially available isohexane as well as the boiling point of commercial n-hexane. As used herein, “boiling point” refers to the corrected thermometer reading that is observed at the instant the first drop of condensate falls from the lower end of a condensing tube according to the procedure described by ASTM D86-01 (Standard Test Method for Distillation of Petroleum Products at Atmospheric Pressure).

TABLE 3

| Chemicals | Boiling Point (° F.) |
|---|---|
| n-pentane | 96 |
| 2,2-dimethylbutane | 122 |
| 2,3-dimethylbutane | 136.4 |
| 2-methylpentane | 143.6 |
| 3-methylpentane | 147.2 |
| Com'l n-hexane | 156.2 |

With such different boiling points for each hydrocarbon found within commercial isohexane, the wet bubble point temperature of commercial isohexane mixtures can vary considerably. For an isohexane solvent to approach the physical characteristics of n-hexane, lower molecular weight ancillary hydrocarbons such as pentanes, butanes and propanes should be substantially removed to the extent practicable from isohexane. Moreover, the amounts of isohexane isomers with low boiling points should also be substantially minimized to the extent practicable, including dimethylbutanes, and more particularly 2,2-dimethylbutane. Conversely, isohexane used in the process for oil extraction should suitably mostly comprise methylpentanes, and more particularly 3-methylpentane, due to their high boiling points. By manipulating the proportionate blend of each of these hydrocarbon compounds, an isohexane solvent can be constructed that more closely approaches the physical characteristics of commercial n-hexane and preclude as much as possible the necessity to alter the variable conditions of the oil extraction process.

The isohexane solvent employed in the present process generally includes at least about 84 wt. % methylpentane, and contains no more than about 7 wt. % 2,2-dimethylbutane, 0.1 wt. % hydrocarbons having fewer than 6 carbon atoms, and no more than about 10 ppm benzene. Such an isohexane solvent substantially reduces the amount of light hydrocarbons, which is commonly present in commercial isohexane, and also increases the higher boiling point methylpentanes. Preferably, such an isohexane solvent is selected to have a wet bubble point temperature at 375 mm Hg of at least 97° F.

The isohexane solvent may suitably include a methylpentane content of at least about 85 wt. % methylpentane, with solvents having a methylpentane content of at least about 90 wt. % being even more well-suited for controlling vaporization of the isohexane solvent during processing. Commonly, the methylpentane fraction of the solvent is a mixture of isomers, e.g., the solvent contains at least about 10 wt. % 2-methylpentane and contains at least about 10 wt. % 3-methylpentane. It is particularly advantageous to employ isohexane solvents in the present process which include a substantial amount of 3-methylpentane, the highest boiling isohexane isomer. In order to reduce vaporization associated issues, the content of 3-methylpentane within the isohexane solvent should suitably remain at or above 25 wt. %, with at least about 35 wt. % 3-methylpentane being more desirable.

The isohexane solvent employed in the present process typically also includes no more than about 10 wt. % dimethylbutane. As noted herein, it is advantageous to limit the amount of the lowest boiling isohexane, 2,2-dimethylbutane, in order to minimize the vapor load associated with the present process. The dimethylbutane within the isohexane solvent should contain no more than about 5 wt. % 2,2-dimethylbutane, with preferably no more than about 3 wt. % 2,2-dimethylbutane and even more preferably no more than about 1 wt. % 2,2-dimethylbutane (wt. % as a percentage of the total amount of solvent).

As indicated, the isohexane solvent generally has less than 0.1 wt. % hydrocarbons having less than 6 carbon atoms. Examples of such hydrocarbons would include pentanes, butanes, propanes and combinations or variations thereof. It would be apparent that other lighter hydrocarbons should also be excluded to the extent practicable.

The isohexane solvent is preferably selected to have a wet dew point at 325 mm Hg of at least 98° F., although this may increase or decrease depending on vaporization requirements of a particular oil processing system. An alternative embodiment of the isohexane solvent may be selected to have a wet dew point at 325 mm Hg of at least 98° F. Further, the isohexane solvent commonly has a dry point of no more than 160° F. As used herein, “dry point” refers to the corrected thermometer reading that is observed at the instant the last drop of liquid (exclusive of any drops or film of liquid on the side of the flask or on the temperature sensor), evaporates from the lowest point in the distillation flask as determined by ASTM D86-01 (Standard Test Method for Distillation of Petroleum Products at Atmospheric Pressure).

The isohexane solvent may also be composed of at least about 99 wt. % saturated aliphatic hydrocarbons having 6 carbon atoms. Other exemplary embodiments of the isohexane solvent may have at least about 99 wt. % branched saturated aliphatic hydrocarbons having 6 carbon atoms, and even more preferably 99.9 wt. % branched saturated aliphatic hydrocarbons having 6 carbon atoms. The isohexane solvent desirably contains no more than about 1 wt. % n-hexane and 10 parts per million benzene.

Another suitable solvent for use in the present process is an aliphatic hydrocarbon solvent which includes at least about 90 wt. % methylpentane; no more than about 3 wt. % 2,2-dimethylbutane; no more than 1 wt. % n-hexane; no more than about 0.1 wt. % hydrocarbons having less than 6 carbon atoms; and no more than 10 parts per million benzene. Such solvents commonly include a mixture of methylpentane isomers, e.g., the solvent contains at least about 20 wt. % 2-methylpentane and contains at least about 20 wt. % 3-methylpentane.

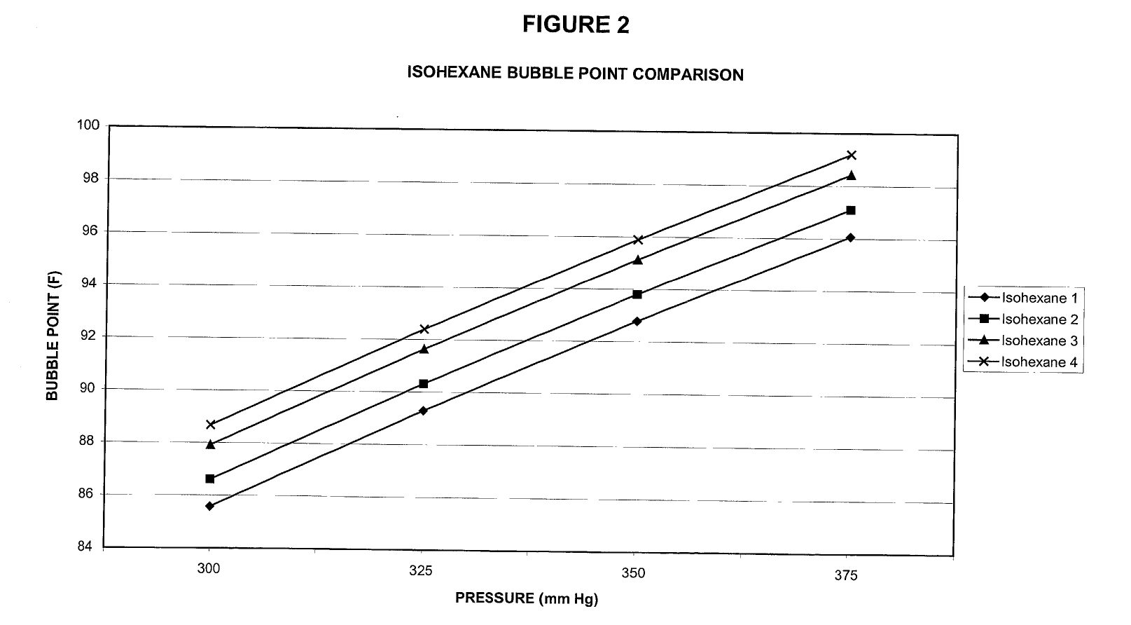

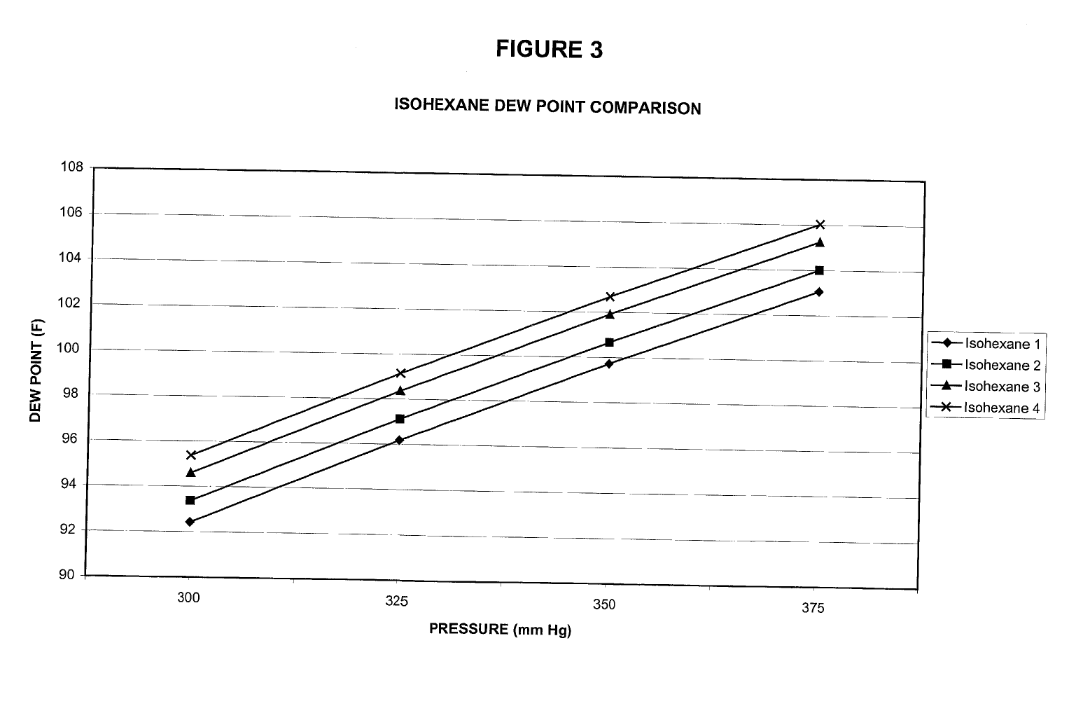

Now referring to FIGS. 2 and 3, the wet bubble points and wet dew points of the four isohexanes shown and described in Table 1 above are graphed at various pressure gradients. FIG. 2 illustrates the fact that the wet bubble point of each isohexane is dependent upon pressure. Isohexane 1 (a comparison commercial isohexane) consistently exhibits the lowest wet bubble point temperatures at each pressure, due in large part to the content and proportion of methylpentane and dimethylbutane. Conversely, Isohexane 4 consistently has the highest wet bubble point temperatures at each pressure. The wet bubble point temperature as a function of pressure is substantially linear for each isohexane in the pressure range between about 300 and 400 mm Hg. At temperatures greater than the wet bubble point for each isohexane at any particular pressure, at least a portion of the isohexane is in the vapor phase. FIG. 3 illustrates similar tendencies of the isohexanes with respect to wet dew point temperature.

During the initial distillation stage, when energy (heat) is first applied to the oil-containing fraction after leaving the extractor to promote separation of the oil from the solvent, the isohexane solvent vapor phase produced also has a temperature which is dependent on the system pressure. The solvent is desirably selected such that the vapor phase has a temperature of at least X°F, where

X=97+((P−350)/7.14),

and no more than Y°F, where

Y=105+((P−350)/7.14),

and P is the pressure in mm Hg.

Commonly, the solvent is selected and the system is operated such that the system pressure in the solvent removal stage has a value of about 300 to 400 mm Hg. More desirably, the solvent is selected such that the vapor phase has a temperature of at least X°F, where X=98+((P -350)/7.14). Solvents which allow the solvent removal to be conducted with a vapor phase temperature of at least X°F, where X=99+((P -350)/7.14) are particularly desirable. At the temperatures in the ranges described in this paragraph, the isohexane solvent is readily converted into the vapor phase and permits vaporization of substantially all of the solvent from the oil. The residual isohexane solvent in the extracted oil after distillation when heating the vapor phase as described herein is generally no more than about 250 parts per million, and more commonly no more than about 100 parts per million.

The examples described herein illustrate hydrocarbon solvent compositions that are particularly suitable for use in the present process for oil extraction. The solvent compositions can exhibit significantly more desirably physical properties than those shown by current commercial isohexane blends, resulting in less capital improvement costs associated with converting oil extraction systems designed for use with commercial n-hexane solvents over to use with an isohexane solvent.

The invention has been described with reference to various specific embodiments and techniques. The examples described herein illustrate but do not limit the scope of the invention that has been set forth herein. It should be noted that the descriptions of various embodiments provided in this disclosure may be of overlapping scope. The embodiments discussed in this disclosure are merely illustrative and are not meant to limit the scope of the present invention, or equivalents thereof. It should be understood that many variations and modifications may be made while remaining within the spirit and scope of the invention.

What is claimed is:

1. A process for separating oil from oil-containing solids comprising:
contacting the oil-containing solids with an isohexane solvent to form an extraction mixture;
wherein the isohexane solvent has a wet dew point at 325 mm Hg of at least 97° F. and comprises:
at least about 85 wt. % methylpentane; and
no more than about 0.1 wt. % hydrocarbons having less than 6 carbon atoms.

2. The process of claim 1, wherein the isohexane solvent has a wet dew point at 350 mm Hg of at least 101° F.

3. The process of claim 1, wherein the isohexane solvent has a wet dew point at 325 mm Hg of no more than 105° F.

4. The process of claim 1, wherein the isohexane solvent further comprises no more than about 10 wt. % dimethylbutane.

5. The process of claim 1, wherein the isohexane solvent further comprises no more than about 3 wt. % 2,2-dimethylbutane.

6. The process of claim 1, wherein the isohexane solvent includes at least about 35 wt. % 3-methylpentane.

7. The process of claim 1, wherein the isohexane solvent includes no more than about 1 0 parts per million benzene.

8. The process of claim 1, wherein the isohexane solvent includes at least about 25 wt. % 3-methylpentane and no more than about 3 wt. % 2,2-dimethylbutane.

9. The process of claim 1, wherein the oil-containing solids are derived from plant material.

10. The process of claim 9, wherein the plant material includes material derived from plants selected from the group consisting of corn, soybean, coconut, safflower, sunflower, cotton, rape, sesame, palm, flax, peanut, and any combination thereof.

11. The process of claim 9, wherein the plant material includes corn germ.

12. The process of claim 9, wherein the plant material includes soybeans.

13. The process of claim 1, wherein the isohexane solvent includes at least 99.9 wt. % branched saturated aliphatic hydrocarbons having 6 carbon atoms.

14. The process of claim 1, further comprising separating the extraction mixture into a solids-containing fraction and an oil-containing solvent fraction.

15. The process of claim 14, further comprising separating the oil-containing solvent fraction into a low solvent-oil fraction and an oil-depleted solvent fraction.

16. The process of claim 15, wherein separating the oil-containing solvent fraction includes heating the oil-containing solvent fraction under vacuum to form the low solvent-oil fraction which includes no more than about 100 ppm isohexane solvent.

17. A process for separating oil from oil-containing solids comprising:
contacting the oil-containing solids with an isohexane solvent to form an extraction mixture;
wherein the isohexane solvent has a wet bubble point at 375 mm Hg of at least 97° F. and comprises at least about 85 wt. % methylpentane.

18. The process of claim 17, wherein the isohexane solvent includes at least about 90 wt. % methylpentane.

19. The process of claim 17, wherein the isohexane solvent includes no more than about 3 wt. % 2,2-dimethylbutane.

20. The process of claim 17, wherein the isohexane solvent has a wet bubble point at 375 mm Hg of no more than 102° F.

21. A process for separating oil from oil-containing solids comprising:
contacting the oil-containing solids with an isohexane solvent to form an extraction mixture;
wherein the isohexane solvent comprises:
at least about 84 wt. % methylpentane;
no more than about 7 wt. % 2,2-dimethylbutane;
no more than about 0.1 wt. % hydrocarbons having less than 6 carbon atoms; and
no more than 10 parts per million benzene.

22. The process of claim 21, wherein the isohexane solvent includes at least about 35 wt. % 3-methylpentane.

23. The process of claim 21, wherein the isohexane solvent includes at least 99.95 wt. % branched saturated aliphatic hydrocarbons having 6 carbon atoms.

24. A process for separating oil from oil-containing solids comprising:
contacting the oil-containing solids with an aliphatic hydrocarbon solvent to form an extraction mixture;
wherein the aliphatic hydrocarbon solvent has a wet bubble point at 760 mm Hg of 134.5° F. to 140° F. and comprises:
at least about 85 wt. % methylpentane; and
no more than about 1.0 wt. % n-hexane.

25. The process of claim 24, wherein the aliphatic hydrocarbon solvent includes no more than about 10 wt. % dimethylbutane.

26. The process of claim 24, wherein the aliphatic hydrocarbon solvent includes no more than about 3 wt. % 2,2-dimethylbutane.

27. The process of claim 24, wherein the aliphatic hydrocarbon solvent includes at least about 30 wt. % 3-methylpentane.

28. The process of claim 24, wherein the aliphatic hydrocarbon solvent includes at least 99.9 wt. % branched saturated aliphatic hydrocarbons.

29. The process of claim 24, wherein the aliphatic hydrocarbon solvent includes at least 99 wt. % saturated aliphatic hydrocarbons.

30. The process of claim 24, wherein the aliphatic hydrocarbon solvent includes no more than about 0.1 wt. % hydrocarbons having less than 6 carbon atoms and no more than about 10 ppm benzene.

31. An isohexane solvent comprising:
at least 90 wt. % methylpentane;
at least 1 wt. % 2,3-dimethylbutane;
no more than 1 wt. % 2,2-dimethylbutane;
no more than 1 wt. % n-hexane;
no more than 0.1 wt. % hydrocarbons having less than 6 carbon atoms; and
no more than 10 parts per million benzene.

32. The isohexane of claim 31 having a wet bubble point at 375 mm Hg of at least 98° F.

33. The isohexane of claim 31 having a wet dew point at 325 mm Hg of at least 98° F.

34. The isohexane of claim 33 having a dry point of no more than 160° F.

35. A method of producing a plant based oil product comprising:
separating a solids-containing fraction from an oil-containing solvent fraction; and
transferring energy to the oil-containing solvent fraction in an initial distillation stage to produce a vapor phase at a pressure P in mm Hg and having a temperature of at least X°F and no more than Y°F where:
X=97+((P−350)/7.14);
Y=105+((P−350)/7.14); and
P has a value of about 300 to 400 mm Hg.

36. The method of claim 35, wherein:
X=98+((P−350)/7.14).

37. The method of claim 35, further comprising contacting an oil-containing solids with an isohexane solvent to form an extraction mixture; and separating the extraction mixture into the solids-containing fraction and the oil-containing solvent fraction; wherein the isohexane solvent comprises
at least 90 wt. % methylpentane;
no more than 1 wt. % n-hexane;
no more than 0.1 wt. % hydrocarbons having less than 6 carbon atoms; and
no more than 10 parts per million benzene.
